(19) United States
(12) Patent Application Publication
(10) Pub. No.: US 2025/0319623 A1
(43) Pub. Date: Oct. 16, 2025

(54) SAWING DEVICE COMPRISING AN EMERGENCY BRAKE UNIT AND METHOD FOR MAKING A TRIGGERED EMERGENCY BRAKE UNIT READY FOR OPERATION

(71) Applicant: Festool GmbH, Wendlingen (DE)

(72) Inventors: Josua Frank, Urbach (DE); Jonathan Caputo, Althengstett (DE); Michael Majer, Notzingen (DE); Markus Schmid, Uhingen (DE); Christian Schock, Schorndorf (DE)

(73) Assignee: Festool GmbH, Wendlingen (DE)

(21) Appl. No.: 18/863,163

(22) PCT Filed: May 9, 2023
(86) PCT No.: PCT/EP2023/062285

§ 371 Date: Nov. 5, 2024

(30) Foreign Application Priority Data
May 12, 2022 (EP) 22172993.2

(51) Int. Cl. B27B 5/38; B27G 19/00; B27G 19/02

(52) U.S. Cl. CPC B27B 5/381; B27G 19/008; B27G 19/025

(57) ABSTRACT

A sawing device has a frame, a circular disc-shaped saw blade mounted rotatably with respect to the frame, and an emergency brake unit. The emergency brake unit has a blocking element, an actuator unit and a control unit. The blocking element has a bearing portion and a head portion designed to engage into the saw blade selectively for braking. The actuator unit is coupled to the blocking element in a normal blocking element position, such that the blocking element engages with the saw blade selectively with the actuator unit. The blocking element can be selectively disassembled from the frame separately from the actuator unit and/or from the control unit. A triggered emergency brake unit of a sawing device ready for operation may be provided. In this regard, a blocking element is disassembled separately from the actuator unit and/or separately from the control unit and an unused blocking element is mounted.

The invention relates to a sawing device comprising a frame, a circular disc-shaped saw blade mounted so as to be rotatable with respect to the frame, and an emergency brake unit.

The invention is also directed to a method for making a triggered emergency brake unit of a sawing device ready for operation.

Sawing devices comprising emergency brake units are known from the prior art.

The emergency brake unit is used to stop rotation of the saw blade if there is a threat of, or an existing, risk of injury. In this manner, injuries to users of the sawing devices are avoided or at least the severity thereof is reduced. In other words, safe operation of the sawing device is ensured.

In particular in applications in which it is to be expected that the emergency brake unit is triggered comparatively frequently, it is important from the point of view of operating efficiency that a saw with a triggered emergency brake unit can be made ready for operation again rapidly and simply. Only then can the user continue to work on the machining task promptly. In this manner, safe operation of the sawing device can be combined with high operating efficiency. From an economic point of view, as little cost as possible should also be incurred by triggering the emergency brake unit and making a triggered emergency brake unit ready for operation.

It is therefore the object of the present invention to improve sawing devices and associated methods for making a triggered emergency brake unit ready for operation to such an extent that increased operating efficiency can be achieved whilst maintaining the known high level of operating safety.

The object is achieved by a sawing device comprising a frame, a circular disc-shaped saw blade mounted so as to be rotatable with respect to the frame, and an emergency brake unit. The emergency brake unit comprises a blocking element, an actuator unit and a control unit which is integral with the actuator unit or is coupled by signal technology to the actuator unit. The blocking element comprises a bearing portion, via which the blocking element is mounted on the frame, and a head portion. The head portion is designed to engage into the saw blade selectively for braking purposes. The actuator unit is coupled to the blocking element, at least in a normal position of the blocking element, such that the blocking element can be brought into engagement with the saw blade selectively by means of the actuator unit. In addition, the blocking element can be selectively disassembled from the frame separately from the actuator unit and/or separately from the control unit. In the present case, the normal position of the blocking element is to be understood to be that position in which it has not yet engaged into the saw blade. The normal position can thus also be referred to as the untriggered position. Furthermore, “can be disassembled separately from the actuator unit and/or separately from the control unit” means that the blocking element can be disassembled from the sawing device without the actuator unit and/or the control unit of the emergency brake unit having to be disassembled at the same time. Of course, this does not include mounting elements, bearing elements, holding elements and fastening elements, by means of which the blocking element is mounted. In other words, the blocking element can be singularly disassembled in relation to the actuator unit and/or the control unit. Therefore, the blocking element can be replaced alone or singularly. The actuator unit and/or the control unit remain mounted on the sawing device when such a replacement occurs. As a result, the blocking element can be disassembled rapidly and simply. In principle, this applies to all operating states of the sawing device and the emergency brake unit, but in particular for a state after triggering of the emergency brake unit, i.e. when the blocking element engages or has engaged into the saw blade. Therefore, the emergency brake unit and the sawing device can be returned into operation rapidly and simply after triggering of the emergency brake unit. A machining task can thus be continued and completed promptly. The fact that the blocking element can be replaced singularly also ensures that the triggering of the emergency brake unit and the act of making the triggered emergency brake unit ready for operation incur comparatively low costs.

In a preferred embodiment, the blocking element can be disassembled separately from all of the remaining components of the emergency brake unit. In other words, the blocking element can be singularly disassembled in relation to all of the remaining components of the emergency brake unit. The effects and advantages explained are particularly clearly apparent.

In a further preferred embodiment, the blocking element, the actuator unit and the control unit of the emergency brake unit can each be disassembled separately from all of the remaining components of the emergency brake unit. In other words, the blocking element can be singularly disassembled in relation to all of the remaining components of the emergency brake unit. In addition, the actuator unit can be singularly disassembled in relation to all of the remaining components of the emergency brake unit. Moreover, the control unit of the emergency brake unit can be singularly disassembled in relation to all of the remaining components of the emergency brake unit. Therefore, individual components of the emergency brake unit can be replaced, repaired and/or maintained in a simple manner.

In a first alternative, the control unit of the emergency brake unit can be integral with a motor control unit which is used to control a drive motor configured for driving the saw blade. In a second alternative, the motor control unit and the control unit of the emergency brake unit are formed separately. However, they can be connected by signal technology to each other, and so the drive motor can be simply and reliably deactivated when the emergency brake unit is triggered.

Said effects and advantages of the invention are particularly clear in comparison with known emergency brake units for sawing devices. In the case of such emergency brake units, the blocking element, the associated actuator unit and the control unit are designed as a module. After triggering of the emergency brake unit, the entire module, i.e. the blocking element and also the actuator unit and the control unit, must always be replaced.

In this regard, a sawing device having a circular disc-shaped saw blade can also be referred to as a circular sawing device or simply as a circular saw. Examples of such sawing devices are mitre saws, circular bench saws, circular hand saws and plunge saws.

Blocking elements for emergency brake units of sawing devices are also known colloquially as brake wedges. This is irrespective of whether the blocking element is wedge-shaped or acts as a wedge.

It is also understood that the emergency brake unit is coupled to a sensor unit for detecting when a user actually contacts, or is about to contact, the saw blade, and is operated in dependence upon a detection result of the sensor unit. In this manner, the emergency brake unit can be triggered in a timely and purposeful manner. Injuries to the user of the sawing device can thus be avoided entirely or at least the severity thereof can be reduced.

In this regard, the actuator unit of the emergency brake unit can comprise an actuator which can be triggered selectively, in particular in dependence upon the detection result. The blocking element, more precisely the associated head portion, can thus be brought quickly and reliably into engagement with the saw blade by means of the actuator. The actuator comprises e.g. a lifting magnet or a shape memory alloy actuator. It is also possible to use a pretensioned spring, which can be released by means of a fusible wire, as the actuator.

The sawing device can comprise a guide element. The guide element is configured to guide the blocking element at least in a guide direction which extends at least in sections in parallel with a circumferential direction of the saw blade. This is particularly important when the blocking element engages into the saw blade with its head portion. In such a situation, the kinetic energy of the rotation of the saw blade must be introduced in a targeted manner into the blocking element and absorbed by the blocking element. The guide element prevents the blocking element from being deformed or displaced in an undesirable manner. Guiding in a guide direction which extends at least in sections in parallel with a circumferential direction of the saw blade allows movement of the blocking element in parallel with the circumferential direction. Movement in parallel with an axial direction of the saw blade is prevented by the guide element. Movement in a direction radially with respect to the saw blade may be permitted or prevented depending upon the application. As a result, the guide element ensures that the saw blade is braked by means of the blocking element with a high level of reliability.

According to one embodiment, the blocking element is connected to the frame via a bearing element. The bearing element can be singularly disassembled from the sawing device, i.e. from the frame. In this embodiment, the bearing element and also the blocking element can be singularly disassembled. The singular disassembly capability of the bearing element ensures the singular disassembly capability of the blocking element. In other words, the bearing element must be disassembled in order to be able to disassemble the blocking element. Furthermore, further components of the emergency brake unit do not need to be disassembled. By way of the bearing element which can be singularly disassembled, the blocking element on the one hand can be reliably mounted on the frame, so that comparatively high forces can also be transferred between the blocking element and the frame. On the other hand, the blocking element can still be simply and rapidly disassembled.

The sawing device can comprise a locking mechanism, by means of which the bearing element can be selectively locked on the frame and selectively unlocked from the frame. The bearing element is thus secured to the frame in such a manner that it is not separated from the frame in an undesirable manner.

Examples of locking mechanisms include a thread, into which the bearing element is screwed, an eccentric mechanism, via which the bearing element is fixedly clamped, and locking wings which are arranged at an end of the bearing element and engage behind an associated frame portion in a form-fitting manner in the locked condition.

In one variant, the guide element is mounted on the frame by means of the bearing element. The bearing element is thus used to mount the blocking element and also to mount the guide element. Therefore, components can be saved compared with mounting the blocking element and the guide element with separate, specific bearing elements. As a result, the sawing device can be built in a comparatively simple and compact manner.

In another alternative, the blocking element is mounted on the frame by means of a fixed bearing element. In addition, a holding element for holding the blocking element on the bearing element is provided. The blocking element can be reliably mounted on the frame via the fixed bearing element. In particular, comparatively high forces can be transferred between the blocking element and the frame. In order to disassemble the blocking element, only the holding element has to be disassembled or moved into a release position. Therefore, the blocking element can be simply and rapidly disassembled.

The holding element can also be selectively singularly disassembled from the bearing element. In this embodiment, the holding element and also the blocking element can be singularly disassembled. The singular disassembly capability of the holding element ensures the singular disassembly capability of the blocking element. In other words, the holding element must be disassembled in order to be able to disassemble the blocking element. Furthermore, further components of the emergency brake unit do not need to be disassembled.

Examples of holding elements include a nut, which is screwed onto the bearing element, and securing rings which are coupled to the bearing element in form-fitting or force-fitting manner.

In one exemplified embodiment, the holding element is formed by a portion of the guide element. There is thus a portion of the guide element which is configured to hold the blocking element on the bearing element. In particular, such a portion of the guide element blocks movement of the blocking element in a direction of extension of the bearing element, i.e. in an axial direction of the bearing element. In this regard, the guide element can be mounted separately on the frame so that it can selectively assume an operating position, in which it holds the blocking element on the bearing element, and can assume a release position, in which it allows disassembly of the blocking element from the bearing element.

The bearing element can be a bearing pin. The blocking element can be mounted in a rotatable manner via the bearing pin. Such a bearing element is constructed in a comparatively simple manner and can reliably mount the blocking element. The rotatable mounting arrangement ensures that the blocking element can be brought into engagement with the saw blade in a simple and reliable manner.

In one embodiment, the blocking element comprises a coupling portion, via which the blocking element is coupled to the actuator unit at least in the normal position. The coupling portion can be positioned at an end of the blocking element opposite the bearing portion. The blocking element can thus be selectively brought into engagement with the saw blade by means of the actuator unit via the coupling portion. Positioning the coupling portion on an end of the blocking element opposite the bearing portion ensures that the blocking element can engage into the saw blade with a high level of reliability and precision. Undesired interactions between the coupling portion and the bearing portion are excluded or at least reduced to a low amount.

In this regard, a clamping element can be provided which couples the actuator unit to the blocking element in a force-fitting manner at least in the normal position. Alternatively, a form-fitting element can be provided which couples the actuator unit to the blocking element in a form-fitting manner at least in the normal position. The actuator unit and the blocking element are thus coupled in a simple and reliable manner at least in the normal position. Such a coupling can also be released and then re-established rapidly and simply during replacement of the blocking element.

In an end position, the blocking element can be decoupled at least from a portion of the actuator unit. The end position relates to a position of the blocking element after it has been brought into engagement with the saw blade by means of the actuator unit, i.e. a position after triggering of the emergency brake unit. Owing to the already released coupling to the actuator unit, the blocking element can be disassembled from the emergency brake unit in a particularly simple manner and can be replaced by an unused blocking element.

The actuator unit can also be selectively singularly disassembled from the frame. Once again, the singular disassembly capability relates to the remaining components of the emergency brake unit. Therefore, the actuator unit can be replaced alone as required, without other components of the emergency brake unit having to be disassembled at the same time. The emergency brake unit is thus particularly repair-friendly. It is emphasised that in a preferred embodiment the actuator unit is configured to be used in a plurality of triggering processes of the emergency brake unit. As standard, the actuator unit does not have to be replaced after the emergency brake unit is triggered.

It is preferable if at least one of the blocking element and actuator unit can be disassembled in a tool-free manner. In other words, at least one of the blocking element and actuator unit can be disassembled by hand, in particular without the use of tools. As a result, disassembly is particularly simple.

According to one variant, the bearing portion and the head portion are at substantially the same distance from a central axis of the saw blade in the normal position. The blocking element is thus arranged on the one hand in a space-saving manner within the sawing device and on the other hand is positioned in such a way that the head portion of the blocking element only has to cover a comparatively small distance in order to engage into the saw blade. Furthermore, by way of such an arrangement forces introduced into the blocking element can be reliably supported via its bearing portion. On the whole, the saw blade can be brought to a standstill comparatively quickly and reliably.

Provision can additionally be made that the blocking element comprises a deformation portion which is located between the bearing portion and the head portion and/or connects the bearing portion and the head portion to one another. The deformation portion can be arcuate and designed to be plastically shortened in order to brake the saw blade in an arc circumferential direction. Therefore, the kinetic energy of the rotation of the saw blade can be converted reliably and purposefully into a plastic shortening of the deformation portion. This is achieved in particular by the arc shape of the deformation portion and its position between the bearing portion and the head portion. Therefore, rotation of the saw blade can be stopped in a comparatively short time. Since the deformation portion is specifically designed to be plastically shortened in the arc circumferential direction, it can absorb a comparatively large amount of kinetic energy in relation to the installation space occupied by the deformation portion and convert it into plastic shortening. This also means that forces resulting from the braking of the saw blade are absorbed by the deformation portion in a reliable and targeted manner. As a result, only comparatively small forces act upon the remaining components of the emergency brake unit. The same applies to components of the sawing device. As a result, the remaining components of the emergency brake unit and the components of the sawing device are not influenced in terms of their functional efficiency by a braking procedure brought about by the blocking element. This applies in particular to the saw blade which can continue to be used when the sawing device is put back into operation.

The arcuate deformation portion preferably extends concentrically to the circular disc-shaped saw blade.

The object is further achieved by a method for making a triggered emergency brake unit of a sawing device ready for operation. The sawing device comprises a circular disc-shaped saw blade. The emergency brake unit comprises a blocking element which is configured to selectively engage into the saw blade in order to brake the saw blade. The method comprises the following steps:
disassembling the blocking element separately from an actuator unit of the emergency brake unit and/or separately from a control unit of the emergency brake unit, wherein the blocking element engages into the saw blade or has been in engagement with the saw blade,
mounting an unused blocking element.

In this regard, a condition arises in which the blocking element engages into the saw blade or has been in engagement with the saw blade when the emergency brake unit has been triggered and the saw blade has been braked by means of the blocking element. In emergency brake units of the type which is relevant here, as a result of the triggering of the emergency brake unit the blocking element which is damaged and/or deformed by the triggering must be replaced by an unused blocking element. As already mentioned, against this background the phrase “disassembling the blocking element separately from an actuator unit of the emergency brake unit and/or separately from a control unit of the emergency brake unit” means that the blocking element can be disassembled from the sawing device without the actuator unit of the emergency brake unit and/or the control unit of the emergency brake unit having to be disassembled at the same time. As already mentioned, this does not include mounting elements, bearing elements, holding elements and fastening elements, by means of which the blocking element is mounted. In this regard, mention can also be made of singularly disassembling the blocking element, wherein “singularly” refers again to the actuator unit and/or the control unit of the emergency brake unit. Therefore, the blocking element can be replaced alone or singularly in order to make the sawing device ready for operation. The actuator unit and/or the control unit of the emergency brake unit remain mounted on the sawing device when such a replacement occurs. The blocking element can thus be replaced rapidly and simply by an unused blocking element. Therefore, the emergency brake unit and the sawing device can be made ready for operation rapidly and simply after triggering of the emergency brake unit. A machining task can thus be continued and completed promptly. The fact that the blocking element can be replaced singularly also ensures that the triggering of the emergency brake unit and the act of making the triggered emergency brake unit ready for operation incur comparatively low costs.

In a preferred embodiment, the blocking element is disassembled separately from all of the remaining components of the emergency brake unit. In other words, the blocking element is singularly disassembled in relation to all of the remaining components of the emergency brake unit. The effects and advantages explained are particularly clearly apparent.

In a further preferred embodiment, the blocking element, the actuator unit and the control unit of the emergency brake unit are each disassembled separately from all of the remaining components of the emergency brake unit. In other words, the blocking element is singularly disassembled in relation to all of the remaining components of the emergency brake unit. In addition, the actuator unit is singularly disassembled in relation to all of the remaining components of the emergency brake unit. Moreover, the control unit of the emergency brake unit is singularly disassembled in relation to all of the remaining components of the emergency brake unit. Consequently, individual components of the emergency brake unit can be replaced, repaired and/or maintained in a simple manner.

In one variant, when mounting the unused blocking element the unused blocking element is coupled to an actuator unit of the emergency brake unit. That is, the actuator unit is not replaced. In subsequent operation of the sawing device, the blocking element can be selectively brought into engagement with the saw blade by the coupling action.

In one embodiment, in order to disassemble the blocking element a bearing element, by means of which the blocking element is mounted in the sawing device, is disassembled. Alternatively, a holding element is removed from a fixed bearing element, by means of which the blocking element is mounted in the sawing device. In both variants, the blocking element can thus be disassembled rapidly and simply. This can be effected preferably in a tool-free manner.

The holding element can be formed by a portion of a guide element and removing the holding element from the fixed bearing element comprises moving the guide element into a release position. Moving into the release position comprises for example folding, pivoting, rotating and/or pushing the guide element. Preferably, the guide element is not separated from the frame of the sawing device. In this manner, the holding element can be removed from the fixed bearing element in a particularly rapid and simple manner. The blocking element can thus be replaced in a particularly rapid and simple manner.

The invention will be explained hereinafter with the aid of various exemplified embodiments which are illustrated in the attached drawings. In the figures:

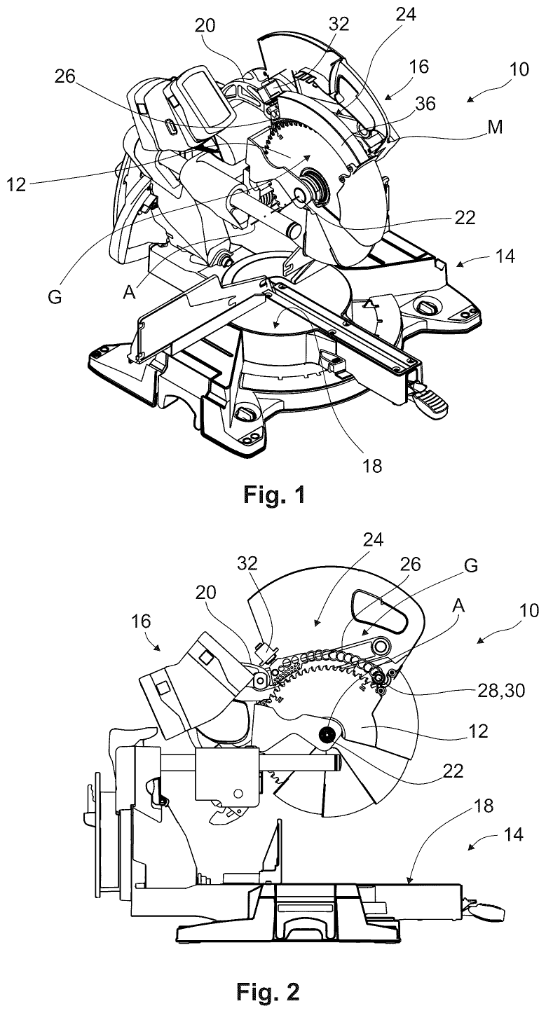

FIG. 1 shows a perspective view of a sawing device in accordance with the invention, wherein the sawing device in accordance with the invention comprises an emergency brake unit which is equipped with a blocking element and can be made ready for operation by means of a method in accordance with the invention,

FIG. 2 shows the sawing device of FIG. 1 in a side view, wherein a guide element of the emergency brake unit is left out,

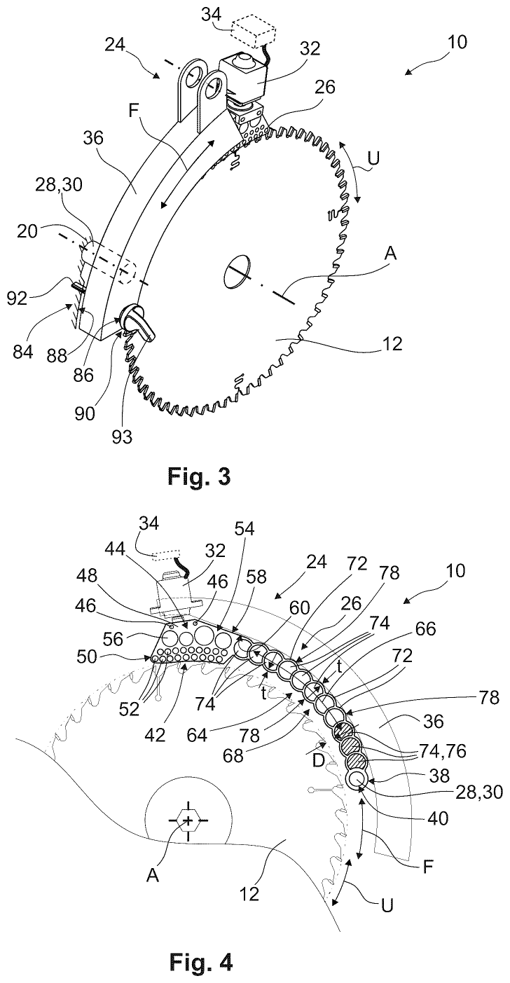

FIG. 3 shows parts of the sawing device of FIGS. 1 and 2 in a separate view, shows a detailed view of the blocking element, FIG. 4

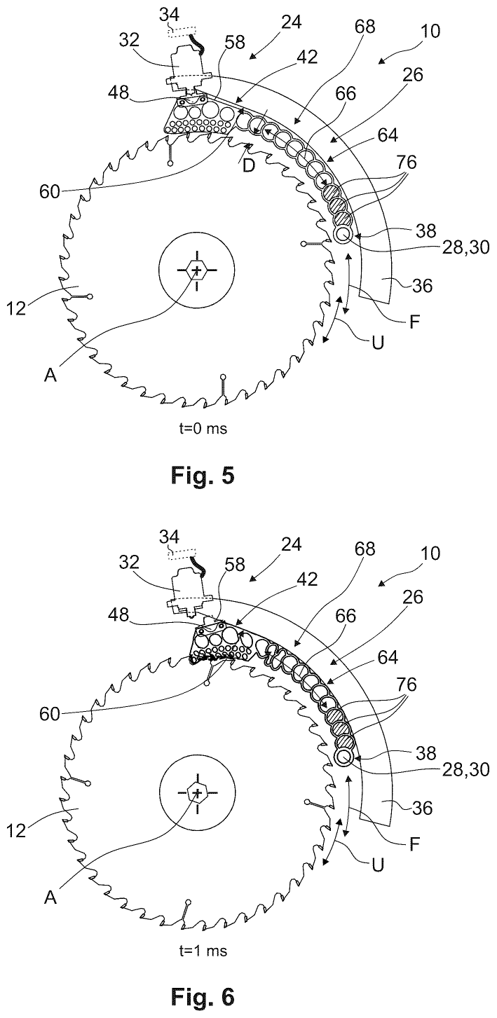

FIGS. 5 to 8 show parts of the sawing device of FIGS. 1 and 2 at different points in time after the triggering of the emergency brake unit,

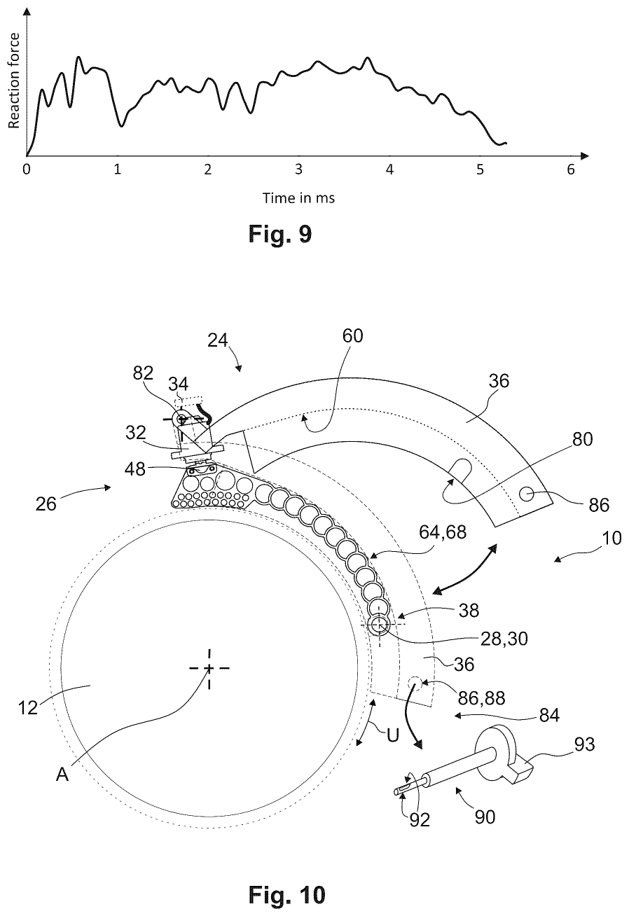

FIG. 9 shows a curve of a force, which is absorbed by the blocking element, over time after the triggering of the emergency brake unit,

FIG 10 shows parts of the sawing device of FIGS. 1 and 2 during mounting of the blocking element,

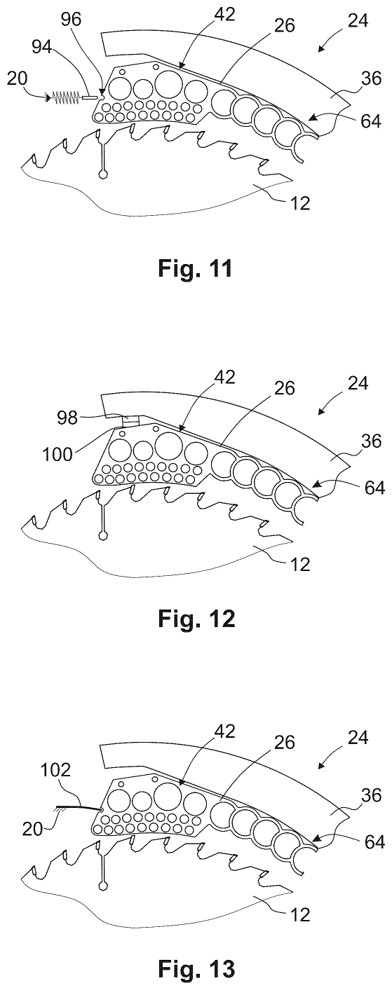

FIGS. 11 to 14 show alternative embodiments for holding the blocking element in a normal position,

FIG. 15 shows parts of a sawing device according to an alternative embodiment,

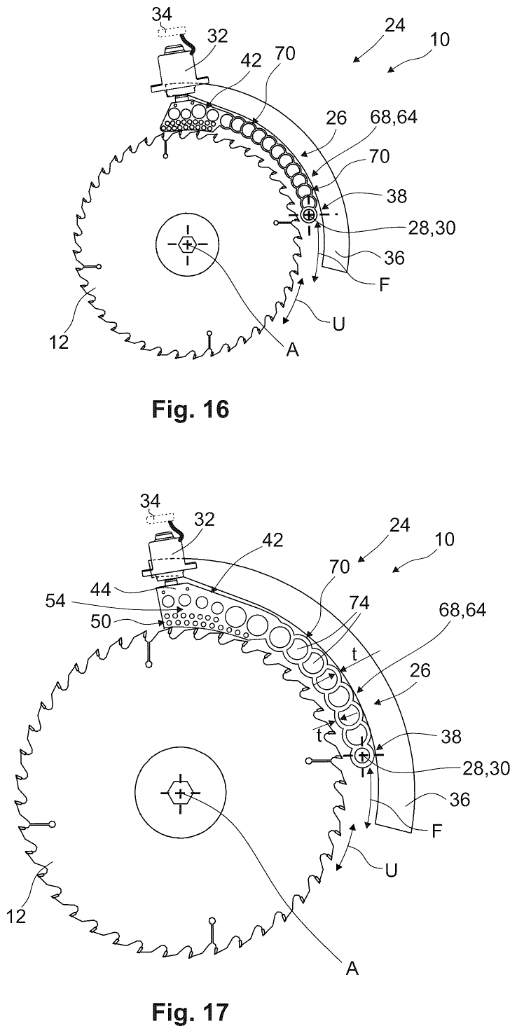

FIG. 16 shows parts of a sawing device according to another alternative embodiment,

FIG. 17 shows parts of a sawing device according to a further alternative embodiment, and

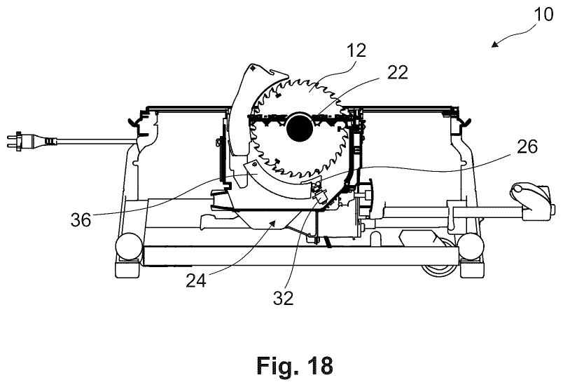

FIG. 18 shows an additional embodiment of a sawing device in accordance with the invention.

FIGS. 1 and 2 show a sawing device 10 having a circular disc-shaped saw blade 12. In the illustrated example, the sawing device 10 is a mitre saw.

The sawing device 10 comprises a base assembly 14 and an arm assembly 16 rotatably mounted thereon.

The base assembly 14 has a support surface 18 on which a component to be machined, i.e. to be sawn off or sawn, can be positioned.

Furthermore, the saw blade 12 can be set in rotation about a central axis A by actuating a drive motor M coupled thereto and can be brought into interaction with the component to be machined by displacing the arm assembly 16 relative to the base assembly 14.

In the example shown, the displacement of the arm assembly 16 relative to the base assembly 14 is effected manually.

The arm assembly 16 or, more generally, the sawing device 10 comprises a frame 20, on which a drive shaft 22 is mounted so as to be able to be driven rotationally. The drive shaft 22 is drivingly coupled to the drive motor M. The saw blade 12 is fixed on the drive shaft 22 and so the saw blade 12 can be rotationally driven in a known manner.

Furthermore, the sawing device 10 is equipped with an emergency brake unit 24 which can be seen in detail in FIGS. 3 and 4.

In order to be able to see the emergency brake unit 24 more clearly, a housing part is not illustrated in a region G in FIGS. 1 and 2. On the one hand, such a housing part serves to remove workpiece particles, e.g. sawdust or dust generated by the use of the sawing device 10. On the other hand, a portion of the handle provided at the end of the arm assembly 16 is formed by means of such a housing part in the illustrated embodiment. Furthermore, the housing part serves to cover the saw blade 12.

The emergency brake unit 24 comprises a blocking element 26 which is mounted on the sawing device 10 so as to be able to rotate via a bearing element 28 fixed to the frame 20 and in the form of a fixed bearing pin 30 such that it can selectively engage into the saw blade 12 in order to brake the saw blade 12.

Moreover, the emergency brake unit 24 comprises an actuator unit 32 which is configured to bring the blocking element 26 selectively into engagement with the saw blade 12.

In the illustrated example, the actuator unit 32 comprises for this purpose an electrically activatable lifting magnet which is not illustrated in greater detail in the figures.

The emergency brake unit 24 also comprises an associated control unit 34.

In the illustrated embodiment, the control unit 34 is designed and arranged separately from the actuator unit 32 (see e.g. FIGS. 3 to 8). The actuator unit 32 and the control unit 34 are coupled by signal technology via a signal line.

This configuration ensures that the actuator unit 32 and the control unit 34 can be disassembled separately from one another. This makes replacement, repair or maintenance easier.

The control unit 34 is coupled to a sensor unit, which is known per se, in order to detect when a user actually contacts or is about to contact the saw blade 12.

Therefore, the actuator unit 32 can be operated in dependence upon a detection result of the sensor unit.

Furthermore, the emergency brake unit 24 has a guide element 36 which is mounted on the frame 20 and guides a movement of the blocking element 26 in a guide direction F, as will also be explained in detail hereinafter.

The blocking element 26 is located in a normal position in FIGS. 3 and 4. In this position, the blocking element is arranged in parallel with a circumferential direction U of the saw blade 12.

The blocking element 26 is constructed of three portions 26.

The blocking element 26 comprises a bearing portion 38.

In the illustrated embodiment, the bearing portion 38 is sleeve-shaped, i.e. the bearing portion 38 comprises a circular-cylindrical bearing opening 40 which is defined by a wall 41 having a substantially constant wall thickness.

The fixed bearing pin 30 is received in the bearing opening 40 and so the blocking element 26 is mounted on the frame 20 of the sawing device 10 so as to be able to rotate via the bearing portion 38 and the bearing pin 30.

Furthermore, the blocking element 26 comprises a head portion 42.

The head portion 42 is provided at an end of the blocking element 26 opposite the bearing portion 38.

The head portion 42 is designed, in the event of an actuation of the emergency brake unit 24, i.e. driven by the actuator unit 32, to engage into the saw blade 12 in order to brake said saw blade ideally until it comes to a standstill.

In this regard, the head portion 42 comprises a coupling portion 44.

The coupling portion 44 is positioned at an end of the blocking element 26 opposite the bearing portion 38.

Moreover, the coupling portion 44 is positioned radially on the outside on the head portion 42.

The coupling portion 44 serves two different functions.

Firstly, the coupling portion 44 is designed to introduce an actuating force generated by the actuator unit 32 into the blocking element 26 and so the head portion 42 can engage into the saw blade 12.

Secondly, the coupling portion 44 serves to fix or retain the blocking element 26 at least in the normal position, shown in FIGS. 3 and 4, with respect to the frame 20. Therefore, the head portion 42 in the normal position is prevented from engaging into the saw blade 12.

The functions of the introduction of force and the retention can be implemented separately from one another or collectively, i.e. in combination. The latter is the case in the embodiments shown in FIGS. 1 to 10.

In this case, the coupling portion 44 comprises two coupling openings 46.

In addition, a U-shaped form-fitting element 48 is provided which on the one hand is fastened to the actuator unit 32, e.g. in a form-fitting manner, and which on the other hand has nubs which are complementary to the coupling openings 46 and engage into the coupling openings 46. The form-fitting element 48 is thus coupled in a form-fitting manner both to the blocking element 26 and also to the actuator unit 32.

Thus, on the one hand, an actuating force generated by the actuator unit 32 can be introduced into the blocking element 26 via the form-fitting element 48. On the other hand, the blocking element 26 is retained in the normal position relative to the frame 20 via the form-fitting element 48 and the actuator unit 32.

It is understood that, alternatively, the coupling openings 46 and the allocated nubs can also be omitted. Instead of the U-shaped form-fitting element 48, a likewise U-shaped clamping element is then used which is fixedly clamped on the coupling portion 44, i.e. is connected in a force-fitting manner to the blocking element 26 in the region of the coupling portion 44. The fastening of such a clamping element to the actuator unit 32 can be effected in a form-fitting or force-fitting manner.

Furthermore, the head portion 42 comprises a cutting zone 50.

In the illustrated embodiment, the cutting zone 50 is characterised by a two-row pattern of through-going openings 52. For improved clarity, only some of the through-going openings 52 are provided with a reference sign in the figures.

By means of the through-going openings 52, the material of the head portion 42 is weakened specifically in the region of the cutting zone 50 and so, after triggering of the emergency brake unit 24, the saw blade 12 cuts into the head portion 42 smoothly and over as large a region of said head portion as possible.

This results in a reliable coupling between the saw blade 12 and the blocking element 26 which is necessary in order to reliably brake rotation of the saw blade 12.

A connecting zone 54 is provided substantially between the coupling portion 44 and the cutting zone 50.

In the illustrated embodiment, the connecting zone 54 also comprises through-going openings 56. Again, for improved clarity, only some of the through-going openings 56 are provided with a reference sign in the figures. However, the diameters of the through-going openings 56 of the connecting zone 54 are selected to be considerably larger than the diameters of the through-going openings 52 of the cutting zone 50.

The connecting zone 54 serves on the one hand to transmit an actuating force from the coupling portion 44 to the cutting zone 50. On the other hand, the cutting zone 50 is coupled to the deformation portion, which will be explained hereinafter, via the connecting zone 54.

In this regard, the through-going openings 56 of the connecting zone 54 serve to ensure sufficient rigidity of the connecting zone 54 with the lowest possible mass and thus the lowest possible mass inertia.

Moreover, the head portion 42 is equipped with a guide surface 58.

The guide surface 58 lies against a counter guide surface 60 of the guide element 36.

By reason of the geometry of the head portion 42 and the counter guide surface 60, a force is applied to the head portion 42 in the direction of the saw blade 12 when said head portion is moved clockwise in the circumferential direction U of the saw blade 12 in the view shown in FIG. 4. For this purpose, the guide surface 58 bas a normal with an extension component radially outwards.

As is apparent from the explanations above, in the case of the head portion 42 shown in the figures through-going openings are used in order to create regions of different rigidity and different resistances to cutting by the saw blade 12. It is understood that, as an alternative to the through-going openings, this can also be achieved by providing different materials in the different regions of the head portion 42. In this regard, it may be particularly important to use materials of different ductility.

Located between the head portion 42 and the bearing portion 38, the blocking element 26 comprises a deformation portion 64.

The deformation portion 64 connects the bearing portion 38 and the head portion 42 to one another.

On the whole, the deformation portion 64 is arcuate and in the illustrated exemplified embodiment it is circular arc-shaped.

In this case, an arc circumferential direction 66, i.e. the curved longitudinal extension direction of the arc-shaped deformation portion 64, extends substantially in parallel with the circumferential direction U of the saw blade 12.

In the illustrated embodiment, an outer circumference of the saw blade 12 and the arcuate deformation portion 64 also extend concentrically, wherein the central axis A constitutes the centre.

In the embodiment illustrated in FIG. 4, the deformation portion 64 extends over a portion of the arc circumferential direction 66 at a centre point angle of ca. 60 degrees.

Therefore, the circumferential extension of the deformation portion 64 is essentially twice the circumferential extension of the head portion 42. As a consequence, the head portion 42 is circumferentially shorter than the deformation portion 64.

The deformation portion 64 is also multiple times longer in relation to a circumferential extension of the bearing portion 38.

Moreover, in a radial direction in relation to the central axis A of the saw blade 12, the deformation portion 64 is spaced further apart from the outer circumference of the saw blade 12 than the head portion 42 and the bearing portion 38 are.

In other words, both the head portion 42 and the bearing portion 38 project radially inwards in relation to the deformation portion 64 with respect to the arc circumferential direction 66.

In this regard, the radial distance D of the deformation portion 64 from the saw blade 12 is selected such that it is greater than zero in all operating situations of the emergency brake unit 24. This also applies in particular to an end position of the blocking element 26 to be explained later.

In other words, the distance D of the deformation portion 64 is selected such that it does not contact the outer circumference of the saw blade 12 in any operating situation.

The deformation portion 64 further comprises a structure 68 which can be plastically deformed in the arc circumferential direction 66.

In the embodiment illustrated in FIG. 4, this structure 68 is formed from a total of eleven ring segments 70.

The ring segments 70 are arranged in the arc circumferential direction 66 in an adjacent manner with a slight overlap.

Each of the ring segments 70 has a wall 72 having a substantially constant wall thickness t.

The walls 72 define in each case an axially continuous cavity 74.

For improved clarity, only some of the ring segments 70 and only some of the walls 72 and some of the cavities 74 are provided with a reference sign in the figures.

The structure 68 which can be plastically deformed in the arc circumferential direction 66 thus comprises a total of eleven cavities 74 which are arranged in an adjacent manner in the arc circumferential direction 66.

The slight overlap of the ring segments 70 produces a crescent moon-shaped cross-section for each cavity 74.

Furthermore, a filling material 76 is arranged in each case in the interior of the three cavities 74 which are arranged adjacent to the bearing portion 38.

In the illustrated embodiment, the filling material is a rubber material.

For the remainder, the blocking element 26 is produced from an aluminium alloy.

The filling material 76 gives rise to a different rigidity of the deformation portion 64 in the region of the cavities 74 provided with the filling material 76 than in the region of the unfilled cavities 74. The deformation portion 64 thus comprises two regions having different rigidities or, more generally, a rigidity progression.

It is understood that the rigidity can be set in a targeted manner by a corresponding selection of the filling material 76 and the number and position of the cavities 74 filled with the filling material 76.

The overall effect of the structure 68 is that a rigidity of the deformation portion 64 in the arc circumferential direction 66 is smaller than a rigidity of the head portion 42.

In addition, the structure 68 has desired deformation points 78. In the embodiment illustrated in FIG. 4, they are located in each case in the portions of the ring segments 70 which protrude radially inwards to the furthest extent and in the portions thereof which protrude radially outwards to the furthest extent.

Once again, for improved clarity, only some of the desired deformation points 78 are provided with a reference sign in the figures.

The deformation portion 64 is thus designed to be plastically shortened in order to brake the saw blade 12 in the arc circumferential direction 66. This will be explained hereinafter with reference to FIGS. 5 to 8.

In this regard, FIG. 5 shows the emergency brake unit 24 and in particular the blocking element 26 in the already described normal position. This means that the actuator unit 32 has not yet been actuated in order to effect emergency braking.

Accordingly, a force also does not yet act upon the blocking element 26 (cf. FIG. 9).

As has already been explained, the blocking element 26 is held in the normal position via the form-fitting element 48 and the actuator unit 32.

The position in FIG. 5 corresponds to the situation at 0 milliseconds in the graph of FIG. 9.

It is now assumed that at time zero milliseconds (0 ms) the emergency brake unit 24 is triggered. As a consequence, the actuator unit 32 is actuated and the head portion 42 is urged in the direction of the saw blade 12. In the illustrated exemplified embodiment, this is effected via the form-fitting element 48.

It is understood that at the same time the drive motor M is deactivated and/or decoupled from the drive shaft 22.

FIG. 6 illustrates a situation which arises one millisecond (1 ms) after the triggering. Again, the force curve at 1 ms in FIG. 9 can be allocated to the situation in FIG. 6.

In this situation, the saw blade 12 has cut into the cutting zone 50 and so a force-based coupling is produced between the saw blade 12 and the blocking element 26. By reason of the clockwise rotation of the saw blade 12, at the time illustrated in FIG. 6 the head portion 42 has already been entrained by a certain circumferential distance in the circumferential direction U of the saw blade 12 in contrast to the initial situation of FIG. 5.

This has resulted in the connection between the form-fitting element 48 and the actuator unit 32 being released.

The coupling between the form-fitting element 48 and the head portion 42 has remained in the present case.

It is understood that, alternatively, the connection between the form-fitting element 48 and the head portion 42 can also be disconnected and the connection between the form-fitting element 48 and the actuator unit 32 maintained.

In this regard, the guide element 36 ensures that the blocking element 26 cannot prevent itself from being entrained by the saw blade 12 in either the radial direction or in the axial direction. The blocking element 26 is thus guided in the guide direction F by means of the guide element 36.

Furthermore, the entrainment by the saw blade 12 has caused at least the three ring segments 70 which are arranged adjacent to the head portion 42 to have deformed.

More precisely, these ring segments have been compressed in the arc circumferential direction 66.

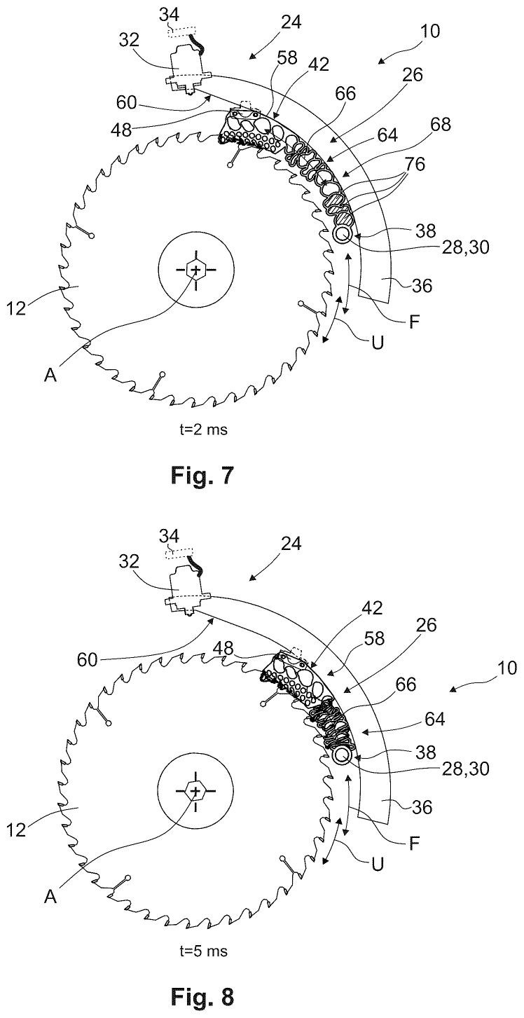

FIG. 7 shows the emergency brake unit 24 after a further millisecond has passed, i.e. 2 milliseconds after the triggering.

The head portion 42 continues to be coupled to the saw blade 12.

Now, however, all ring segments 70 are compressed in the arc circumferential direction 66 and so the deformation portion 64 is already significantly plastically shortened in the arc circumferential direction 66.

The kinetic energy of the rotation of the saw blade 12 is converted into the plastic shortening of the deformation portion 64 in order to brake the saw blade 12.

FIG. 8 shows the emergency brake unit 24 five milliseconds (5 ms) after the triggering. At this time, the saw blade 12 is substantially at a standstill, i.e. it no longer rotates.

The deformation portion 64 is now substantially completely compressed, i.e. the cavities 74 are substantially closed by pushing the deformation portion 64 together in the arc circumferential direction 66.

FIG. 8 thus shows the emergency brake unit 24 at the end of the emergency braking procedure. The associated position of the blocking element 26 is also referred to as the end position.

In order to be able to put the emergency brake unit 24 and the sawing device 10 as a whole back into operation, i.e. to make a sawing device 10, of which the emergency brake unit 24 has been triggered, ready for operation once again, the blocking element 26 must now be replaced.

For this purpose, the blocking element 26 can be selectively disassembled from the frame 20 separately from the actuator unit 32. The blocking element 26 can thus be singularly disassembled. This will be explained in conjunction with FIG. 10.

As already explained, the blocking element 26 is mounted on the frame 20 so as to be able to rotate via the fixed bearing pin 30.

In order to prevent the blocking element 26 from being separated from the bearing pin 30 in an axial direction of the bearing pin, a holding element 80 is provided for holding the blocking element 26 on the bearing pin 30.

In the illustrated embodiment, this holding element 80 is a side wall portion of the guide element 36, i.e. a portion of a wall of the guide element 36 which prevents axial displacement of the blocking element 26.

Consequently, if the guide element 36 is in its operating position illustrated as a dashed line in FIG. 10, the blocking element 26 is held on the bearing pin 30.

The guide element 36 is mounted on the frame 20 so as to be able to rotate via a further bearing element 82 which is likewise designed as a bearing pin.

This allows the guide element 36 to be transferred to a release position for disassembly of the blocking element 26, said release position being illustrated by solid lines in FIG. 10. In the release position, the holding element 80 is removed from the bearing element, i.e. from the bearing pin 30.

In order to prevent the guide element 36 from taking up the release position in an undesirable manner, it can be locked in the operating position by means of a locking mechanism 84 (see also FIG. 3 in addition to FIG. 10).

The locking mechanism 84 comprises a first through-going opening 86 on the guide element 36 and a second through-going opening 88 on the frame 20.

Furthermore, the locking mechanism 84 has a locking pin 90.

At a first end, the locking pin 90 is equipped with locking wings 92 and at a second end, opposite the first end, it is equipped with an operating lever 93.

The locking pin 90 can thus be inserted into the through-going openings 86 and 88 and transferred by means of the operating lever 93 into a rotational position in which the locking wings 92 engage behind a portion of the frame 20.

In another rotational position, the rearward engagement is released and so the locking pin can be pulled axially out of the through-going openings 86 and 88.

By means of the locking mechanism 84, the guide element 36 can thus be selectively locked on the frame 20 and selectively unlocked from the frame 20. Of course, this also applies to the holding element 80 formed by the guide element 36.

Therefore, no tool whatsoever is required in order to operate the locking pin 90 and thus to disassemble the blocking element 26.

Therefore, in order to singularly disassemble the blocking element 26, only the locking pin 90 is unlocked and removed from the frame 20. The guide element 36 is then transferred to the release position and the blocking element 26 is removed from the bearing pin 30 in an axial direction thereof, i.e. is disassembled from the frame.

Then, an unused blocking element 26 is mounted.

For this purpose, the bearing portion 38 of the unused blocking element 26 is placed onto the fixed bearing pin 30.

Furthermore, the unused blocking element 26 is coupled to the actuator unit 32.

Then, the guide element 36 is moved back to the operating position and locked at that location by means of the locking pin 90.

Furthermore, the actuator unit 32 must be returned to its starting position. This can be effected by means of the control unit 34.

The sawing device 10 is now ready for operation again and the emergency brake unit 24 is ready for operation again.

In the case of the emergency brake unit 24 illustrated in FIGS. 1 to 10, the head portion 42 is always selectively brought into engagement with the saw blade 12 by the actuator unit 32 and also held by the actuator unit 32 in the normal position such that the head portion 32 does not unintentionally come into contact with the saw blade 12.

FIGS. 11 to 14 show alternatives for the retention of the blocking element 26 in the normal position. The force is applied, as usual, via a pressure piece coupled to the lifting magnet of the actuator unit 32, said pressure piece being formed to apply an actuating force to the head portion 42 in the direction of the saw blade 12. The pressure piece can be formed as a pushrod.

In this regard, in the alternative according to FIG. 11 the blocking element 26 is held in the normal position by means of a spring-loaded pin 94. For this purpose, the spring-loaded pin 94 engages into an associated depression 96 on a circumferential end side of the blocking element 26.

The actuator unit 32 corresponds to the actuator unit 32 of the embodiment from FIGS. 1 to 10. If this is triggered, it urges the blocking element 26 in the direction of the saw blade 12. As a result, the pin 94 is urged out of the depression 96 against the spring force.

In the alternative of FIG. 12, a magnet 98 and a counter piece 100 consisting of ferromagnetic material are provided. In the illustrated example, the magnet is fastened to the guide element 36 and the counter piece is fastened to the head portion 42 of the blocking element 26.

The pairing of magnet 98 and counter piece 100 is selected such that, by means of the actuator unit 32, the head portion 42 and thus the counter piece 100 can be detached from the magnet 98 against a magnetic force when the emergency brake unit 24 is actuated.

In the alternative of FIG. 13, a leaf spring element 102 is fastened to the frame 20 via a first end. A second end of the leaf spring element 102 is received in a depression 104 which is arranged on the end-side on the blocking element 26. The blocking element 26 is thereby held in the normal position.

The actuator unit 32 again corresponds to the actuator unit 32 of the embodiment from FIGS. 1 to 10. If this is triggered, it urges the blocking element 26 in the direction of the saw blade 12. The leaf spring element 102 is thereby deformed, and so its free end springs out of the depression 104 and releases the blocking element.

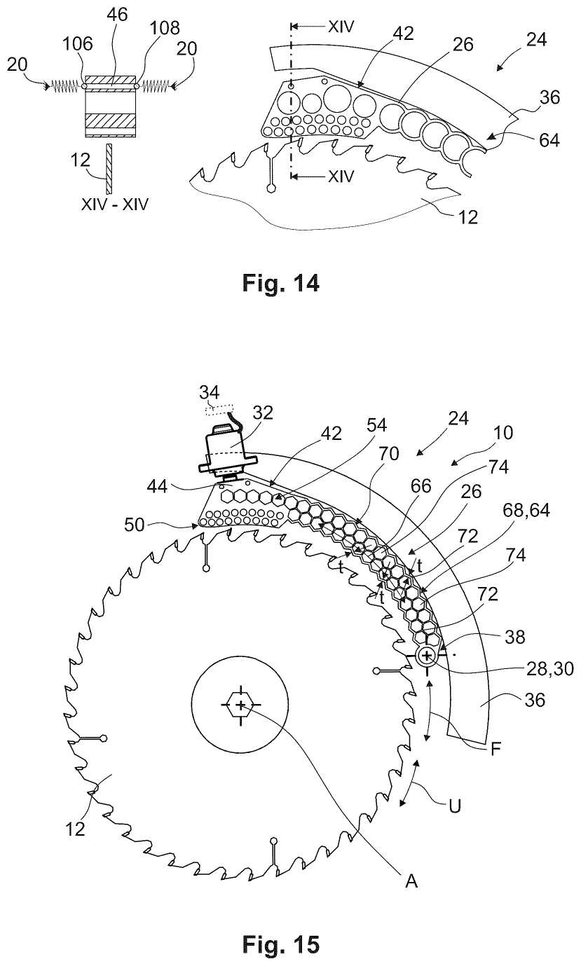

In the alternative of FIG. 14, two balls 106, 108 are provided which each engage at different ends of one of the coupling openings 46.

The balls 106, 108 are spring-loaded and so, when the actuator unit 32 is actuated, they can be urged out of the coupling openings 46 and can thus release the blocking element 26.

FIG. 15 shows sections of an alternative sawing device 10.

Only the differences with respect to the sawing devices 10 already explained will be discussed hereinafter. Identical or mutually corresponding elements are designated by the same reference signs.

The differences relate to the blocking element 26.

Unlike in the previous embodiments, the deformation portion 64 now comprises hexagonal ring segments 70. This means that the walls 72 of the ring segments 70 each form hexagons and the through-going openings 74 which are defined by these walls 72 each form a hexagonal cross-section.

A further difference is that two radially adjacent rows of ring segments 70 are now provided. In addition, each of these rows of ring segments 70 has 16 ring segments 70. There are therefore more ring segments 70 in each row than e.g. in the blocking element 26 of FIG. 4.

The plastically deformable structure 68 of the blocking element 26 of FIG. 15 can also be referred to as a honeycomb structure.

For improved clarity, again only some of the ring segments 70 and only some of the walls 72 and some of the cavities 74 are provided with a reference sign.

The desired deformation points 78 are now formed by those portions of the walls 72 of each ring segment 70 which comprise the corner of the hexagonal cross-section which protrudes radially inwards to the furthest extent and the corner of the hexagonal cross-section which protrudes radially outwards to the furthest extent.

Each ring segment 70 thus comprises two desired deformation points 78, a radially inner one and a radially outer one.

The through-going openings in the head portion 42, or more precisely the through-going openings 56 in the connecting zone 54, now also have hexagonal cross-sections. In addition, they are arranged slightly differently than in the blocking element 26 of FIG. 4.

FIG. 16 shows sections of a further alternative sawing device 10.

Again, only the differences with respect to the preceding embodiments are explained.

The sawing device 10 in FIG. 16 has a considerably smaller saw blade 12 than the sawing devices explained above.

The blocking element 26 does not differ in shape from the blocking element 26 of FIG. 10. It has only been scaled proportionally.

This can be seen in particular by comparing the size of the blocking element 26 and the actuator unit 32 which is identical in the embodiments shown in FIGS. 10 and 16.

FIG. 17 shows sections of another alternative sawing device 10.

Again, only the differences with respect to the preceding embodiments are discussed. They relate again to the blocking element 26.

In the embodiment shown in FIG. 17, the head portion 42 of the blocking element 26 is configured differently.

On the one hand, its end side is no longer pointed but instead is blunt.

On the other hand, this is longer in the arc circumferential direction 66 compared to the previous head portions 42.

This also results in an increased number and changes in the size and position of the through-going bores 56 in the connecting portion 54.

Since the total length of the blocking element 26 in the arc circumferential direction 66 has remained the same, the deformation portion 64 is now shorter. It now comprises a total of only seven ring segments 70. The wall thickness t of the associated walls 72 has been increased in comparison with the embodiment shown in FIG. 4.

For improved clarity, again only some of the ring segments 70 and only some of the walls 72 and some of the cavities 74 are provided with a reference sign.

FIG. 18 shows an additional embodiment of a sawing device 10.

Now, the sawing device 10 is designed as a circular bench saw.

For the remainder, the above explanations apply analogously, in particular with regard to the emergency brake unit 24.

It is noted that in all of the aforementioned embodiments, the actuator unit 32 also can be selectively singularly disassembled from the frame 20. This makes it easy to repair the emergency brake unit 24 in the event that a defect occurs in the actuator unit 32.

The actuator unit 32 can also be disassembled in a tool-free manner.

### LIST OF REFERENCE SIGNS

10 sawing device
12 saw blade
14 base assembly
16 arm assembly
18 support surface
20 frame
22 drive shaft
24 emergency brake unit
26 blocking element
28 bearing element
30 bearing pin
32 actuator unit
34 control unit
36 guide element
38 bearing portion
40 bearing opening
41 wall
42 head portion
44 coupling portion
46 coupling openings
48 form-fitting element
50 cutting zone
52 through-going opening
54 connecting zone
56 through-going opening
58 guide surface
60 counter guide surface
64 deformation portion
66 arc circumferential direction
68 plastically deformable structure
70 ring segment
72 wall
74 cavity
76 filling material
78 desired deformation point
80 holding element
82 bearing element
84 locking mechanism
86 first through-going opening
88 second through-going opening
90 locking pin
92 locking wings
93 operating lever
94 pin
96 depression
98 magnet
100 counter piece
102 leaf spring element
104 depression
106 ball 108 ball
A central axis of the saw blade
D radial distance of the deformation portion from the saw blade
M drive motor
U circumferential direction of the saw blade
F guide direction
G region for a housing part, not illustrated
t wall thickness

1. A sawing device, comprising:
a frame,
a circular disc-shaped saw blade mounted so as to be rotatable with respect to the frame, and
an emergency brake unit, wherein the emergency brake unit comprises a blocking element, an actuator unit and a control unit which is integral with the actuator unit or is coupled by signal technology to the actuator unit,
wherein the blocking element comprises a bearing portion, via which the blocking element is mounted on the frame, and a head portion which is designed to engage into the circular disc-shaped saw blade selectively for braking purposes, wherein the actuator unit is coupled to the blocking element, at least in a normal position of the blocking element, such that the blocking element is configured to engage with the saw blade selectively by the actuator unit, and
wherein the blocking element is configured to selectively disassemble from the frame separately from the actuator unit and/or separately from the control unit.

2. The sawing device as claimed in claim 1, further comprising:
a guide element configured for guiding the blocking element at least in a guide direction which extends at least in sections in parallel with a circumferential direction of the saw blade.

3. The sawing device as claimed in claim 1, wherein the blocking element is connected to the frame via a bearing element, wherein the bearing element is configured to singularly disassemble from the sawing device.

4. The sawing device as claimed in claim 3, further comprising:
a locking mechanism, by which the bearing element is configured to selectively lock on the frame and selectively unlock from the frame.

5. The sawing device as claimed in claim 2, wherein the guide element is mounted on the frame by the bearing element.

6. The sawing device as claimed in claim 1, wherein the blocking element is mounted on the frame by a fixed bearing element and a holding element configured for holding the blocking element on the bearing element.

7. The sawing device as claimed in claim 6, wherein the holding element is configured to selectively singularly disassemble from the bearing element.

8. The sawing device as claimed in claim 2, wherein a portion of the guide element forms the holding element.

9. The sawing device as claimed in claim 1, wherein the blocking element comprises a coupling portion, via which the blocking element is coupled to the actuator unit at least in the normal position, wherein the coupling portion is positioned at an end of the blocking element opposite the bearing portion.

10. The sawing device as claimed in claim 1, wherein, in an end position, the blocking element is decoupled at least from a portion of the actuator unit.

11. The sawing device as claimed in claim 1, wherein the blocking element comprises a deformation portion which is located between the bearing portion and the head portion and/or connects the bearing portion and the head portion to one another, wherein the deformation portion is arcuate and designed to be plastically shortened in order to brake the saw blade in an arc circumferential direction.

12. A method for making a triggered emergency brake unit of a sawing device ready for operation, wherein the sawing device comprises a circular disc-shaped saw blade and the emergency brake unit has a blocking element which is configured to selectively engage into the saw blade in order to brake the saw blade, wherein the method comprises:
disassembling the blocking element separately from an actuator unit of the emergency brake unit and/or separately from a control unit of the emergency brake unit, wherein the blocking element engages into the saw blade or has been in engagement with the saw blade, and
mounting an unused blocking element.

13. The method as claimed in claim 12, wherein, when mounting the unused blocking element, the unused blocking element is coupled to an actuator unit of the emergency brake unit.

14. The method as claimed in claim 12, wherein in order to disassemble the blocking element a bearing element, by which the blocking element is mounted in the sawing device is disassembled, or a holding element is removed from a fixed bearing element, by which the blocking element is mounted in the sawing device.

15. The method as claimed in claim 14, wherein a portion of a guide element forms the holding element and removing the holding element from the fixed bearing element comprises moving the guide element into a release position.
